(19) United States
(12) Patent Application Publication
(10) Pub. No.: US 2004/0028053 A1
(43) Pub. Date: Feb. 12, 2004

(54) Direct memory access circuit with ATM support

(75) Inventor: Ian Mes, Nepean (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Catena Networks, Inc., Redwood Shores, CA (US)

(21) Appl. No.: 10/454,750

(22) Filed: Jun. 3, 2003

(30) Foreign Application Priority Data
Jun. 3, 2002 (CA) 2,388,790

(51) Int. Cl. G06F 13/28; H04L 12/56

(52) U.S. Cl. 370/395.7; 370/463; 710/22; 710/308

(57) ABSTRACT

A direct memory access (DMA) circuit reduces the number of processor cycles involved in transmitting and receiving asynchronous transfer mode (ATM) cells. The circuit includes a read sequencer, a write sequencer, an ATM control block, a processor interface block, and a DMA arbitration and control block. The DMA arbitration and control block arbitrates between data transmissions on various subchannels. The ATM control block provides ATM functionality to the DMA circuit. The circuit may also respond to a trigger signal and may generate an interrupt signal. In this manner, the processing involved for DMA of ATM cells is improved.

The present invention relates generally to packet-based networks and specifically to a direct memory access circuit including assembly and disassembly support for packets received from or transmitted to the network.

### BACKGROUND OF THE INVENTION

Asynchronous Transfer Mode (ATM) is a standardized communication protocol that specifies, among other things, a fixed cell length format. An ATM cell comprises a five-byte header and a 48-bytes payload. The header format is illustrated below in Table 1. Each row in Table 1 comprises one byte, or eight bits, of the header. Thus, each table entry is four bits.

TABLE 1

| | |
|---|---|
| GFC | VPI |
| VPI | VCI |
| VCI | VCI |
| VCI | PT, CLP |
| HEC | HEC |

Generic Flow Control (GFC) allows subscriber equipment to control the flow of ATM cell. A Virtual Path Identifier (VPI) is used to identify a group of virtual channels within the same endpoint. Virtual Channel Identifiers (VCIs) are used for identifying the virtual channels. A three-bit Payload Type (PT) identifier indicates the type of data found in the payload portion of the cell, including signaling information, network management messages, and other forms of data. A one-bit Cell Loss Priority (CLP) parameter prioritizes cells. In the event of congestion or some other trouble, a node can discard cells that have a CLP value of one, considered low priority. If the CLP value is zero, the cell has a high priority and should only be discarded if it cannot be delivered. The Header Error Control (HEC) is used for error checking in the header. Typically, the HEC is calculated in accordance with the first four bytes of the header.

ATM Adaptation Layers (AALs) are protocols used for sending various types of data over ATM networks. AAL0 is a raw ATM format. It comprises a five-byte header and a 48 byte payload. AAL1 and AAL2 include additional control bytes, which are carried in the payload instead of the header.

AAL5 is a protocol that can be used to carry user data over multiple cells, referred to as a packet. The payload across multiple cells comprises packet data, padding, a trailer and a cyclic redundancy check (CRC). The packet data comprises 0 to 65535 bytes of data. The padding comprises between 0 and 47 bytes and is added such that the sum of the user data, padding, trailer and CRC is a multiple of 48 bytes. The trailer comprises two control bytes and two length bytes. The CRC is calculated from the user data, padding, and trailer, using a standard algorithm. The CRC is used at the receiving end to determine whether there was any data corruption. The header for the last ATM cell in each packet will further include a flag to indicate the end of the packet.

However, in order to facilitate ATM data transfer, it is required to assemble ATM cells for transfer and disassemble them upon receipt. As a result, the cells are transferred to a dedicated unit for performing such operations, which are typically referred to as segmentation and reassembly. However, the process of transferring the data to such dedicated units often consumes clock cycles, which would be preferable to avoid if possible. Therefore, there is a need for a system that performs segmentation and reassembly while consuming a minimal number of clock cycles. Accordingly, it is an object of the present invention to obviate or mitigate at least some of the above-mentioned disadvantages.

### SUMMARY OF THE INVENTION

It is an advantage of the present invention that transmitting cells between an ATM interface and a processor memory consumes a minimal number of processor cycles.

In accordance with an aspect of the present invention there is a provided a direct memory access circuit including ATM support for transferring data between an ATM interface and a memory. The circuit comprises: a read interface for reading data from the memory; a write interface for writing data to the memory; a processor interface for interfacing with a processor for controlling operation of the circuit; an ATM control unit for determining and verifying ATM protocol specific components of the data as required; and an arbitration unit for arbitrating access of the read and write interfaces to the memory.

In accordance with yet a further aspect of the present invention there is provided a method for reducing a number of clock cycles required to transfer data between an ATM interface and a memory using a DMA circuit. The method comprising the steps of: programming the circuit with a plurality of predefined parameters; arming a sub-channel upon programming of the circuit; and transferring the data for the sub-channel between the ATM interface and the memory upon gaining access to the memory in accordance with the predefined parameters.

### BRIEF DESCRIPTION OF THE DRAWINGS

Embodiments of the invention will now be described by way of example only with reference to the following drawings in which:

FIG. 1 is a block diagram of an ATM network interface in accordance with an embodiment of the present invention;

FIG. 2 is a detailed block diagram of a direct memory access circuit illustrated in FIG. 1;

FIG. 3 is detailed a block diagram of an alternate embodiment of the direct memory access circuit illustrated in FIG. 2;

FIG. 4 is a flow chart illustrating the operation of an embodiment of the invention for simple data transfers;

FIG. 5 is a flow chart illustrating the operation of an embodiment of the invention for ATM data transfers; and

FIG. 6 is a flow chart illustrating the operation of an embodiment of the invention for AAL5 data transfers.

### DETAILED DESCRIPTION OF THE PREFERRED EMBODIMENTS

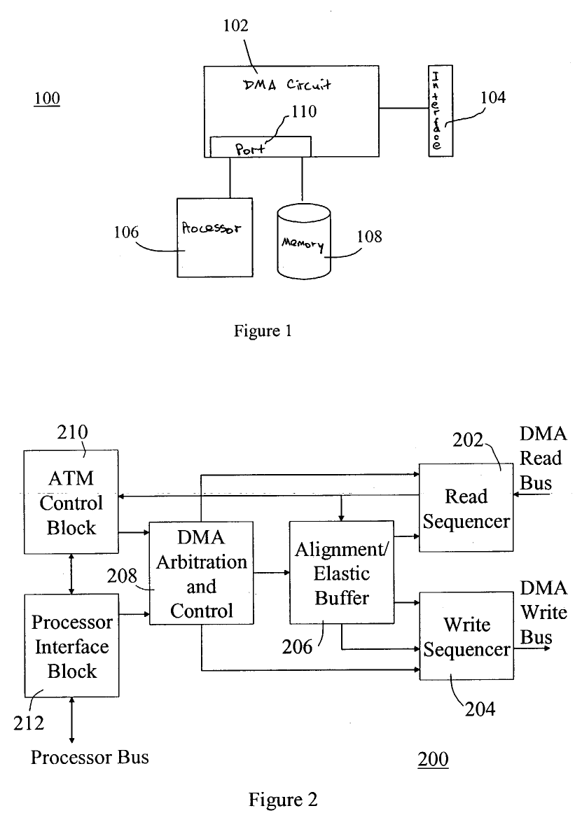

For convenience, like numerals in the description refer to like structures in the drawings. Direct Memory Access (DMA) is a term used to describe a block of hardware that can access processor memory without using the processor. Referring to FIG. 1, a block diagram of an ATM network interface is illustrated generally by numeral 100. The network interface 100 includes a Direct Memory Access (DMA) circuit 102, an ATM interface 104, a processor 106, processor memory 108, and a processor memory port 110.

The DMA circuit 102 is coupled to an ATM network via the ATM interface 104. The DMA circuit 102 is further coupled to the processor 106 and processor memory 108 via the processor memory port 110. The DMA circuit 102 transfers cells between the ATM interface 104 and the processor memory 108. The DMA circuit 102 transfers blocks of data from one memory location to another location. A source address, destination address, and length of the transfer can be programmed by the processor 106 or can be controlled by the ATM control circuitry.

The processor 108 programs the DMA circuit 102 via the processor memory port 110, controlling what type of cell assembly or disassembly to be performed by the DMA circuit 102, as well as other parameters, such as an address within the processor memory to which the data is written or from which the data is read.

Referring to FIG. 2, a block diagram of a circuit for performing direct memory access (DMA) in accordance with an embodiment of the present invention is illustrated generally by numeral 200. The circuit 200 includes a read sequencer 202, a write sequencer 204, a buffer 206, a DMA arbitration and control unit 208, and ATM control block 210, and a processor interface block 212.

The read sequencer 202 reads data out of memory. It can read data out of a processor memory or an external interface. Multiple bytes can be transferred within a given cycle, up to the width of the memory being read. It has its own port to processor memories, so an arbiter (not shown) is used at the memory (not shown) to arbitrate access between the processor bus, the DMA read bus, and the DMA write bus. The read sequencer can be given a single location to transfer, or a range of locations to transfer, referred to as a burst. In the event of a burst, both the start address and length of the burst are provided to the read sequencer 202 by the DMA arbitration and control block 208. The read sequencer 202 stalls if the memory it is reading from is busy, or if the buffer 206, to which it writes, is too full.

The write sequencer 204 writes data to memory. Similar to the read sequencer 202, the write sequencer 204 can write data to the processor memory or to the external interface. Multiple bytes can be transferred within a given cycle, up to the width of the memory being written. It has its own port to processor memories, so an arbiter is used at the memory to arbitrate between the processor bus, the DMA read bus, and the DMA write bus. The write sequencer 204 can be given a single location to transfer, or a range of locations to transfer, referred to as a burst. In the event of a burst, the start address and burst length are provided to the write sequencer 204 by the DMA arbitration and control block 208. The write sequencer 204 stalls if the memory it is writing to is busy, or if the buffer 206, from which it reads, is empty.

The buffer 206 buffers data between the read sequencer 202 and the write sequencer 204. The buffer 206 serves two purposes; as an alignment buffer, and as an elastic buffer.

The buffer 206 acts as an alignment buffer by re-arranging bytes if the read and write transfers are misaligned. The read sequencer 202 and write sequencer 204 have data buses composed of multiple bytes. In order for a byte to be written to the correct location, it must be located in the correct position on the data bus. The alignment buffer uses the lower significant bits of the read and write addresses, which it gets from the DMA arbitration and control block 208, to shift the bytes into the correct position.

The buffer 206 further acts as an elastic buffer. As previously described, both the read or write sequencers 202 and 204 can stall while trying to access a memory. The elastic buffer helps speed up transfers by allowing one of the sequencers to continue operating in the event that the other sequencer is stalled by its target memory. The elastic buffer stops the read sequencer if it is too full to accept more data, and stops the write sequencer if it cannot deliver an entire bus width of data and there is more data to be read.

The DMA arbitration and control block 208 controls the read and write sequencers 202 and 204. It arbitrates between the different sub-channels and controls when each sub-channel starts or stops transferring data. When a sub-channel is programmed by the processor (not shown), it is considered to be armed. If the transfer is programmed to begin immediately, it is considered to be pending.

The DMA arbitration and control block 208 arbitrates between all pending sub-channels, granting requests to the sub-channel with the highest priority setting. If the sub-channel is programmed to do a simple memory transfer, then the source address, destination address and length of transfer are retrieved from the processor interface block 212. If, however, the sub-channel is programmed to assemble or disassemble ATM cells, then the source address, destination address and length of transfer are retrieved from the ATM control block 208. Note that an ATM cell will always require more than one data transfer. At minimum, a header transfer and a payload transfer are required, as will be described in detail with reference to the operation of the circuit.

The DMA arbitration and control block 208 completes an entire cell before arbitrating again for a new access. For AAL5 packet assembly or disassembly, the DMA arbitration and control block will complete one entire cell transfer and then rearm the sub-channel and arbitrate again for a new access to send the next cell in the packet.

The ATM control block 210 includes an ATM sequencer, a HEC calculator, and a CRC calculator. The ATM sequencer uses parameters stored in the program interface block 212 for determining the source address, destination address and length of transfer. When transferring a cell, multiple transfers are required. At the very least, a header transfer and a payload transfer are required. The ATM control block 210 controls all the required transfers and indicates when a cell transfer is complete. The ATM control block 210 also generates a HEC for outgoing cells, and checks the HEC for incoming cells.

Yet further, for AAL5 traffic, the ATM control block 210 generates a CRC for outgoing traffic, and verifies the CRC for incoming traffic. It also keeps track of the source and destination address information. The ATM control block 210 inserts the padding bytes, as required, and the trailer for outgoing traffic. For incoming traffic, it copies the trailer and packet length to registers.

The processor interface block 212 is a collection of registers used to control the operation of the circuit 200. The processor can write to or read from the registers in order to program a sub-channel or check on the status of a sub-channel.

There is an additional path from the read and write sequencers to the ATM control block and processor interface block so that the DMA can transfer headers, trailers, padding bytes, HEC values and CRC values.

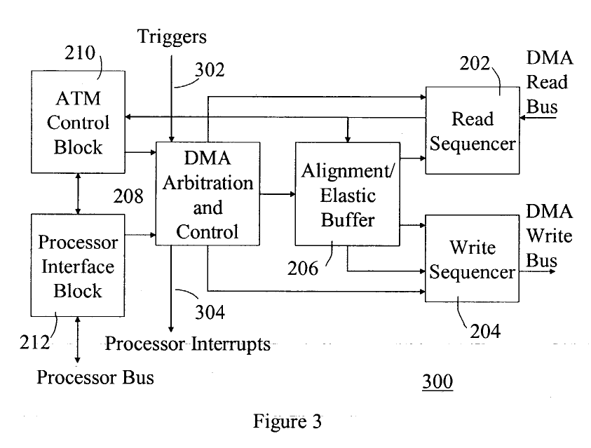

Referring to FIG. 3, an alternate embodiment of the circuit shown in FIG. 2 is illustrated generally by numeral 300. The circuit 300 of the present embodiment is similar to the circuit 200 of the previous embodiment, except for two optional signals.

A first option signal is a trigger 302. The trigger 302 is a signal generated from an external interface for indicating to the DMA arbitration and control block 208 that a cell can be transferred. The external interface can be, for example, first-in, first-out (FIFO) buffer low or high water mark indicators. These indicators signal that a FIFO has a complete cell that can be read by the DMA or room for a complete cell to be written by the DMA, as will be appreciated by a person skilled in the art. Thus, even though a sub-channel is armed by the processor, the transfer is not considered to be pending until the trigger is activated.

A second optional signal is an interrupt 304. The interrupt 304 is a signal that is generated by the DMA arbitration and control block 208 for interrupting the processor and causing it to run a special routine. The interrupt 304 is used, for example, to indicate that a cell or packet transfer is done. This allows the processor to know when a transfer is completed without needing to continually poll a register to check the status of the transfer.

General operation of these circuits is provided as follows. There are multiple functions that may need to be performed by the DMA circuit. For example, the DMA may be required to transfer cells, without performing any additional operations. In such a case, the DMA simply copies cells from a source address to a destination address. In an alternate example, the DMA may be required to pack data into an ATM cell for transmission and unpack data from an ATM cell upon reception. Detailed operation of the different capabilities of the DMA circuit is provided below.

The DMA arbitration and control block has multiple channels that can be programmed independently. This allows the processor to set up different parameters for different types of traffic that it may be handling. For example, the processor can program channel zero to handle AAL0 cells and channel one to handle AAL5 cells. Each of the parameters can be specified independently per channel. Further, each channel is divided into two sub-channels; a receive sub-channel and a transmit sub-channel. The receive sub-channel supports detaching ATM headers and extracting a packet from AAL5 ATM cells. The transmit sub-channel supports attaching ATM headers and generating AAL5 ATM cells from a packet. Each sub-channel supports a different source and destination address. Also, each sub-channel can be assigned a different priority. If multiple cell transfers are available to be started at once, the sub-channel with the highest priority will be the first to start.

The processor programs the DMA circuit by writing to registers within the processor interface block. The processor programs all required parameters before beginning the first transfer on any given sub-channel. However, some parameters remain constant for a plurality of transfers and, thus, need not be re-programmed.

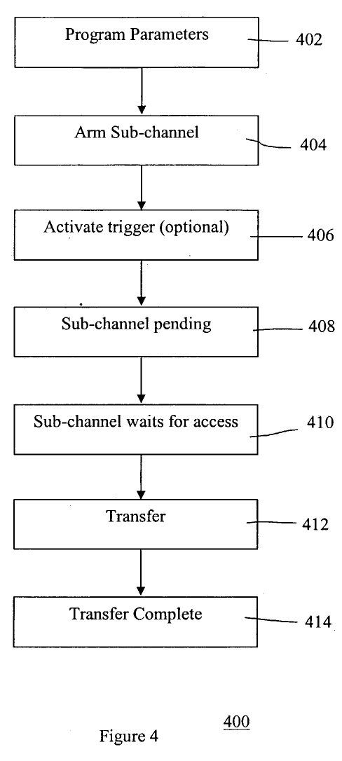

Referring to FIG. 4, a flow chart for the operation of an ATM control circuit for a simple data transfer is illustrated generally by numeral 400. In step 402, the processor programs the necessary parameters for the transfer. These parameters include a source address, destination address, a transfer length and a sub-channel priority for each sub-channel in an identified channel In step 404, when all desired parameters are programmed, the processor writes to a register that arms the sub-channel. If the sub-channel requires a trigger, then it remains armed until the trigger is activated in optional step 406. In step 408, once the trigger is activated, the sub-channel transfer is considered pending. That is, the sub-channel meets all the conditions required by the DMA arbitration and control block in order to perform the transfer. If the sub-channel was not programmed to wait for a trigger, then it will be considered to be pending in step 408 as soon as it is armed in step 404. Once a sub-channel is pending, it waits for all higher priority transfers to be executed. In step 410, the sub-channel waits until all higher priority transfers are completed, at which point the DMA Arbitration and Control block grants it access. In step 412 the sub-channel begins the transfer. The transfer is performed by copying data from the source address to the destination address. If the interrupt is enabled, in step 414 the interrupt signal is raised once the transfer is complete.

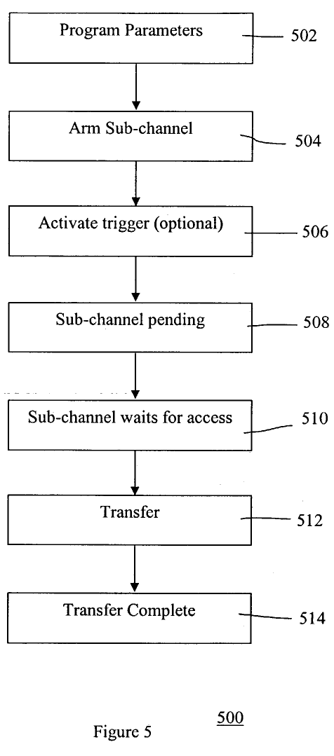

Referring to FIG. 5, the operation of assembling, or transmitting, individual ATM cells illustrated generally by numeral 500. In step 502, the processor programs the necessary parameters for the transfer. These parameters include a source address, a destination address, a header, and a sub-channel priority. Additionally, the processor sets a bit in the sub-channel control register indicating the transfer is an ATM transfer. For the header, the first four bytes are programmed by the processor. The fifth byte, the HEC, is calculated in the ATM control block by hardware or it can be overwritten by software. In step 504, when all the required parameters are programmed, the processor writes to a register that arms the sub-channel. If the DMA includes a trigger, the trigger is armed in step 506. In step 508, once the trigger is activated, the sub-channel transfer is considered pending. If the sub-channel was not programmed to wait for a trigger, then it will be considered to be pending in step 508 as soon as it is armed in step 504. In step 510, the sub-channel waits until all higher priority transfers are completed, at which point the DMA Arbitration and Control block grants it access. In step 512, data is transmitted by the DMA circuit. In the present example, the header is transferred to the destination address, followed by the HEC, followed by 48-bytes of data identified by the source address. If the interrupt in enabled, in step 514, the interrupt is raised once the transfer is complete.

The operation of disassembling, or receiving, individual ATM cells is also represented by FIG. 5. In step 502, the processor programs the necessary parameters for the transfer. These parameters include a source address, a destination address, and a sub-channel priority. Additionally, the processor sets a bit in the sub-channel control register indicating the transfer is an ATM transfer. In step 504, when all the required parameters are programmed, the processor writes to a register that arms the sub-channel. If the DMA includes a-trigger, the trigger is armed in step 506. In step 508, once the trigger is activated, the sub-channel transfer is considered pending. If the sub-channel was not programmed to wait for a trigger, then it will be considered to be pending in step 508 as soon as it is armed in step 504. In step 510, the sub-channel waits until all higher priority transfers are completed, at which point the DMA Arbitration and Control block grants it access. In step 512, data is received by the DMA circuit. In the present example, the header is transferred to the ATM control block, where the HEC is verified. If the received HEC verifies against the locally calculated HEC, the 48 bytes of payload are copied from the source address to the destination address. If the HEC check fails, a flag is raised indicating that an error has occurred. The received ATM cell header is saved into a local register and is not copied to the destination location in the memory. If the interrupt in enabled, in step 514, the interrupt is raised once the transfer is complete.

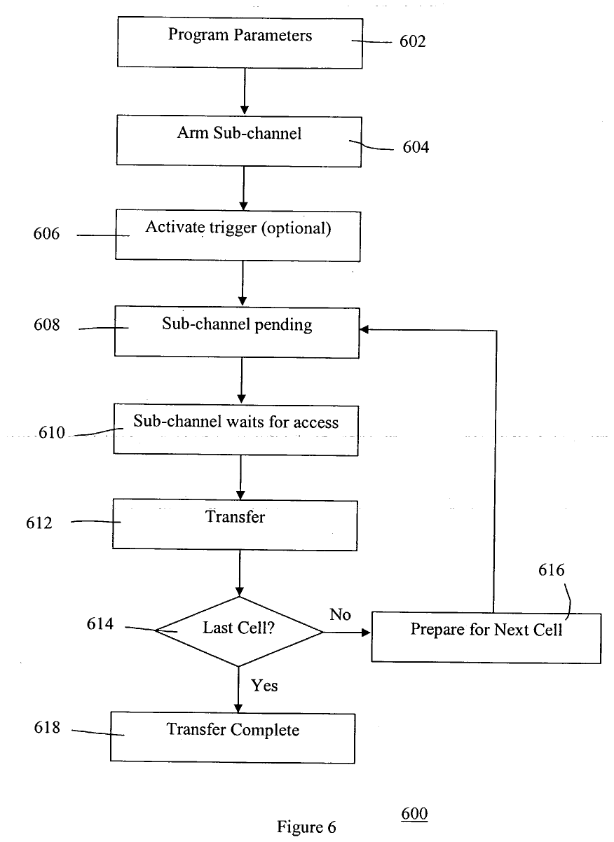

The DMA circuit can also use the ATM control circuitry to assemble or disassemble a user data packet that is sent over several ATM cells via the AAL5 protocol. Referring to FIG. 6, the operation of assembling, or transmitting, ATM cells via the AAL5 protocol is illustrated generally by numeral 600. In step 602, the processor programs the necessary parameters for the transfer. These parameters include a source address, destination address, packet length, packet trailer, packet header, last cell packet header, and padding byte value. The source address is the location where the packet is currently stored. The destination address is the location to where the collection of AAL5 ATM cells is to be sent. The length indicates the length of the raw packet in bytes. The packet trailer is four bytes of data required by the AAL5 protocol. The packet header is the ATM header cell and is used for all AAL5 cells with the exception of the last cell. Only the first four bytes are programmed. The fifth byte, the HEC, is calculated in the ATM control block by hardware or it can be overwritten by software. The last cell packet header is the ATM header cell for the last ATM cell within a packet. Similarly to the previous headers, only the first four bytes are programmed and the HEC is calculated by the ATM control block. The padding byte value is the value that is placed in unused bytes in the last cell. Padding bytes are added so that the entire payload delivered will be a multiple of 48 bytes. The CRC value is calculated by the ATM control block. Further, the ATM control circuitry uses the packet length to determine how many ATM cells need to be sent to encapsulate the entire packet. Additionally, the processor sets a bit in the sub-channel control register indicating the transfer is an AAL5 transfer.

In step 604, when all the required parameters are programmed, the processor writes to a register that arms the sub-channel. If the DMA includes a trigger, the trigger is armed in step 606. In step 608, once the trigger is activated, the sub-channel transfer is considered pending. If the sub-channel was not programmed to wait for a trigger, then it will be considered to be pending in step 608 as soon as it is armed in step 604. In step 610, the sub-channel waits until all higher priority transfers are completed, at which point the DMA Arbitration and Control block grants it access.

In step 612, data is transmitted by the DMA circuit. In the present example, a single AAL5 ATM cell will be sent. How the cell is transmitted depends on its position within the packet. For every cell except the last two cells, the DMA circuit sends a 5-byte header, and 48 bytes of payload. That is, the header is transferred to the destination address, followed by the HEC, followed by 48-bytes of data identified by the source address. Depending on the length of the packet being sent, some padding bytes may be added to the second last packet. The last cell also possibly contains padding bytes. The last eight bytes of the last cell include the trailer and the CRC, which is calculated for the whole packet. Also, the last cell in the packet uses the last cell packet header to indicate the end of the packet.

At step 614 it is determined if the AAL5 cell transmitted was the last cell of the packet. If the transmitted cell is not the last cell of the packet, the operation proceeds to step 616 where preparation for the next cell is made. Typically, the source address is incremented by 48 bytes between each cell. Additionally, the destination address is incremented by 53 bytes between each cell. The sub-channel is automatically re-armed and the operation returns to step 610, where the sub-channel waits until all higher priority transfers are completed and proceeds to transmit the next cell.

If the transmitted cell is the last cell of the packet, and if the interrupt is enabled, in step 618, the interrupt is raised once the transfer is complete.

The operation of disassembling, or receiving, ATM cells via the AAL5 protocol can also be described with reference to FIG. 6. In step 602, the processor programs the necessary parameters for the transfer. These parameters include a source address, a destination address, and a sub-channel priority. The source address is the location where the collection of AAL5 ATM cells is currently stored. The destination address is the location to where the packet will be sent. Additionally, the processor sets a bit in the sub-channel control register indicating the transfer is an AAL5 transfer.

In step 604, when all the required parameters are programmed, the processor writes to a register that arms the sub-channel. If the DMA includes a trigger, the trigger is armed in step 606. In step 608, once the trigger is activated, the sub-channel transfer is considered pending. If the sub-channel was not programmed to wait for a trigger, then it will be considered to be pending in step 608 as soon as it is armed in step 604. In step 610, the sub-channel waits until all higher priority transfers are completed, at which point the DMA Arbitration and Control block grants it access.

In step 612, data is received by the DMA circuit. In the present example, a single AAL5 ATM cell is received at a time. How the cell is received depends on its position within the packet. For every cell except the last cell, the DMA circuit copies the payload of each cell from the source address to the destination address and verifies the HEC on the received cell.

At step 614 it is determined if the AAL5 cell received was the last cell of the packet. The last cell is determined by identifying a last cell flag in the header. If the received cell is not the last cell of the packet, the operation proceeds to step 616 where preparation for the next cell is made. Typically, the source address is incremented by 53 bytes between each cell. Additionally, the destination address is incremented by 48 bytes between each cell. The sub-channel is automatically re-armed and the operation returns to step 610, where the sub-channel waits until all higher priority transfers are completed and proceeds to receive the next cell.

If the received cell is the last cell of the packet, the first 40 bytes of the payload are copied to the destination address. The trailer and the CRC are extracted from the last eight bytes of the payload and put in a register where it can be read by the processor. The length of the packet is extracted from the trailer and put in a separate register where it can also be read by the processor. The length refers to the length of the packet without the padding bytes. Thus, if the AAL5 cells contained padding bytes, they have been written to the destination memory. However, the processor can use the length register to know where the useful data ends. The CRC of the packet is verified against a CRC value calculated locally. If the CRC is incorrect, then an error is flagged and a length of zero is returned in the length register for the packet, effectively dropping the packet. If the interrupt is enabled, in step 618, the interrupt is raised once the transfer is complete.

Thus, the inventions provides a circuit that moves data in and out of processor memory, while adding the ATM functionality. The added ATM functionality includes attaching and detaching ATM headers, checking or generating HEC, generating a stream of AAL5 ATM cells from a block of user data, recovering a block of user data from a stream of AAL5 ATM cells, and checking or generating CRC for AAL5 traffic.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A direct memory access (DMA) circuit including asynchronous transfer mode (ATM) support for transferring data between an ATM interface and a memory, said DMA circuit comprising:
(a) a read interface for reading data from said memory;
(b) a write interface for writing data to said memory;
(c) a processor interface for interfacing with a processor for controlling operation of said DMA circuit;
(d) an ATM control unit for determining and verifying ATM protocol specific components of said data as required; and
(e) an arbitration unit for arbitrating access of said read and write interfaces to said memory.

2. A DMA circuit as defined in claim 1, wherein said circuit is capable of processing a plurality of sub-channels.

3. A DMA circuit as defined in claim 1, wherein said circuit further includes an interface for receiving a trigger signal to indicate that a cell can be transferred.

4. A DMA circuit as defined in claim 3, wherein said trigger signal is generated externally to said circuit.

5. A DMA circuit as defined in claim 3, wherein circuit further includes an interface for transmitting a interrupt signal for signaling an end of a transfer.

6. A DMA circuit as defined in claim 1, further including a buffer coupled between said read and write interfaces.

7. A DMA circuit as defined in claim 6, wherein said buffer is a realignment buffer and rearranges data between said read and write interfaces if said data is misaligned.

8. A DMA circuit as defined in claim 6, wherein said buffer is an elastic buffer and allows one of said read and write interfaces to continue operating for a predefined period of time when the other of said read and write interfaces stalls.

9. A method for reducing a number of clock cycles required to transfer data between an asynchronous transfer mode (ATM) interface and a memory using a direct memory access (DMA) circuit, said method comprising the steps of:
(a) programming said DMA circuit with a plurality of predefined parameters;
(b) arming a sub-channel upon programming of said DMA circuit;
(c) transferring said data for said sub-channel between said ATM interface and said memory upon gaining access to said memory in accordance with said predefined parameters.

10. A method as defined in claim 9, wherein said predefined parameters include a source address, a destination address, a transfer length, and a sub-channel priority.

11. A method as defined in claim 10, wherein said predefined parameters further include a bit to indicate an ATM transfer.

12. A method as defined in claim 11, wherein said step of transferring said data is from said memory to said ATM interface, and said method further includes the step of adding a header associated with said transfer to said data.

13. A method as defined in claim 12, wherein a predefined portion of said header is programmed into said DMA circuit and a remaining portion of said header is determined by said DMA circuit.

14. A method as defined in claim 11, where said step of transferring said data is from said ATM interface to said memory, and said method further includes the step of removing and verifying a header from said data.

15. A method as defined in claim 11, wherein said data is a packet comprising a plurality of cells and said predefined parameters further include a packet trailer, and packet header, a last cell packet header, and a padding byte value.

16. A method as defined in claim 15, wherein said step of transferring said data is from said memory to said ATM interface, and said method further includes the step of adding a header associated with said transfer to said data.

17. A method as defined in claim 16, wherein a predefined portion of said header is programmed into said DMA circuit and a remaining portion of said header is determined by said DMA circuit.

18. A method as defined in claim 17, wherein a last cell in said packet uses said last cell packet header as a corresponding header thereof.

19. A method as defined in claim 18, further comprising the step of calculating and transmitting a cyclic redundancy check value on said packet.

20. A method as defined in claim 15, wherein said step of transferring said data is from said ATM interface to said memory, and said method further includes the step of removing and verifying a header from said data for each of said plurality of cells.

21. A method as defined in claim 20, wherein said method further includes the step of performing a cyclic redundancy check on said packet.
